(19) United States
(12) Patent Application Publication
(10) Pub. No.: US 2010/0074116 A1
(43) Pub. Date: Mar. 25, 2010

(54) System and Method of Controlling a Wireless Radio-Frequency Network Using a Gateway Device

(75) Inventors: Yan Rodriguez, Suwannee, GA (US); Ben Garcia, Cumming, GA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Wayne-Dalton Corp., Mt. Hope, OH (US)

(21) Appl. No.: 12/238,431

(22) Filed: Sep. 25, 2008

(51) Int. Cl. H04L 12/26; H04L 12/28

(52) U.S. Cl. 370/241; 370/254

(57) ABSTRACT

A system and method that create, manage, and maintain a wireless network. The system and method automatically monitor the wireless network and determine an operating status of one or more devices associated with the network. If a determination is made that a device requires attention because of an operating status determined, the system communicates a notification to a designated user providing notice of the operating status. The system may create a proxy of a non-responsive device such that other devices in the network are deceived when communicating with a non-responsive device. The system may be located by a server to enable remote management of the wireless network via the Internet. The system and method enable the creation of scenes and timed events for devices associated with the network. Information tables that provide controller set-ups regarding how the controller communicates within the network may be stored. Devices associated with the network, locations of the devices associated with the network, operating states of the devices, and other information may be determined. Information and routing tables regarding the devices may be determined and communicated to the devices.

### FIELD OF THE INVENTION

The invention relates generally to controlling a wireless radio frequency network. More particularly, the invention relates to the creation, management, and maintenance of a wireless radio frequency network that enables remote control of the wireless radio frequency network by using a gateway device.

### BACKGROUND OF THE INVENTION

Household devices are typically operated independently from one or more command location. A command location may be, for example, a switch, dial, remote control or other location. Many commands in current homes are passed on to a particular device using a physically operated switch. Generally, pressing a switch, turning a dial or other mechanical operation alters a supply of electricity to the device. The switch or dial opens or closes an electrical connection or varies an electrical resistance of that connection that results in the device being turned on or off, an intensity of the device being altered, for example, light or sound or other operation. Someone in the home that desires to alter an operating state of a plurality of devices must individually changes the operating states of each device.

Smart homes are being constructed that enable household devices to be operated from a plurality of devices from a plurality of locations. An example of a wireless network that provides control of home electronics and appliances is Z-WAVE®, provided by Zensys™. In a smart home, a switch can take on functions in addition to regulating electricity flow. Also, additional devices that do not have direct control of electrical load can be present that interact with a communication network. These devices send signals to the communication network informing the network of a desired new operating state of the household device. A controller that is in communication with the household device receives the signal, recognizes that the message is intended for the household device and responds by transmitting a signal that corresponds to the desired new operating state which may be, for example, turning on or dimming a light, opening or closing a garage door, raising or lowering, fully or partially, a window shade, etc. In this manner, electricity regulation can occur at the controller rather than at the household device if desired.

The communication network enables users to change the operating states of one or more devices. The network, however, may appear inactive, sluggish, and/or unresponsive when attempting to communicate with a device that is, for example, broken, unplugged or missing. This is because the controller repeatedly attempts to communicate with the device and does not receive a communication from the device. The user may not be aware that the controller is unable to communicate with the device and may incorrectly believe that the controller is malfunctioning.

These and other problems exist.

### SUMMARY OF THE INVENTION

The foregoing disadvantages are overcome, to a great extent, by the invention, wherein in one aspect, a system and method are provided that in some embodiments enable the creation, management, and maintenance of a local wireless network through the use of a gateway device. According to one embodiment of the invention, a system and method automatically monitor the wireless network and determine an operating status of one or more devices associated with the network. If a determination is made that a device requires attention, the system communicates a notification to a designated user providing notice of the operating status.

According to another embodiment of the invention, the system and method enable the gateway device to be connected to the Internet to enable remote management of the local wireless network via the Internet. The gateway device initiates and transmits a request to a remote server device connected to the Internet, for example, at start-up, periodically, and/or on a scheduled basis, etc. The request enables the gateway device to establish a pathway of communication between the gateway device and the remote server. A user may access the server via the Internet to control the wireless network using the gateway device from a remote location.

According to another embodiment of the invention, the system and method enable the creation of scenes, timed events and action triggered events for devices, and/or scenes associated with the wireless network. The gateway device may also store information tables as a backup location, that provide a plurality of wireless network controller set-ups regarding how controllers for a particular wireless network communicate over the network. The gateway device may also join a network and operate as a device on the network.

In accordance with another embodiment of the invention, the system and method determine devices associated with the network, locations of the devices associated with the network, operating states of the devices, and other information. Information and routing tables may be created for use by other devices on the network and communicated to the other devices via the wireless network.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIGS. 1A-1B illustrate a method of controlling a wireless radio frequency network using a gateway according to one embodiment of the invention.

FIG. 2 is an illustration of a system of controlling a wireless radio frequency network using a gateway according to one embodiment of the invention.

FIG. 3 is a front view of a gateway that may be used to control a wireless radio frequency network according to one embodiment of the invention.

FIG. 4 is a rear view of a gateway that may be used to control a wireless radio frequency network according to one embodiment of the invention.

### DETAILED DESCRIPTION OF THE INVENTION

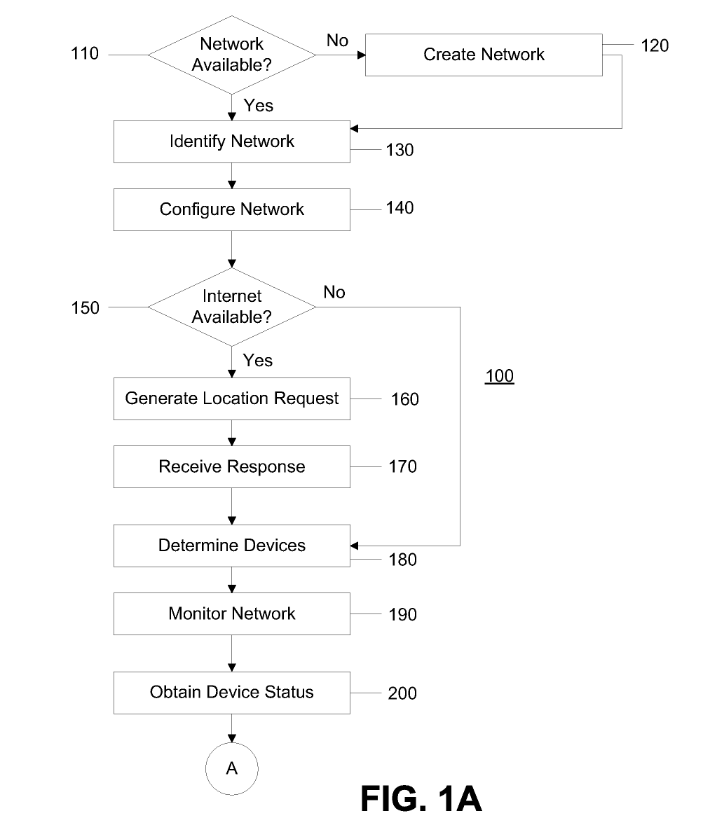

FIGS. 1A and 1B illustrate a method 100 of using a gateway device to control a wireless radio frequency network using an gateway device, according to one embodiment of the invention. Initially, the gateway device determines whether a network is available, step 110. The network may be, for example, a Z-WAVE® network, local area network (LAN) or other network. If a determination is made that a network is not available, the gateway device may create a network, such as, for example, a wireless network, step 120, using any network creating method.

If a determination is made that a network is available, the network may be identified by the gateway device, step 130. The network may be identified, for example, by a Service Set Identifier (SSID), sub-net mask, home-identification, and other information. Upon identifying the network, the network may be configured, step 140. Configuring the network may include, for example, preparing the network for communicating signals among a plurality of transmitting devices, establishing a protocol, channel or other parameter for communicating the signals or other steps. A determination may be made regarding whether access to the Internet is available, step 150.

If a determination is made that access to the Internet is available, a location request, such as, for example, a ping, may be generated by the gateway device, step 160. The location request may be transmitted to a server that enables the server to locate the gateway device that generated the request. The location request may include, for example, an Internet protocol (IP) address or other location enabling information. The server receives the location request and transmits a response to the gateway device that acknowledges a presence of the gateway device on the network.

The response to the location request is received by the gateway device, step 170. After receiving the response, or if a determination is made in step 150 that access to the Internet is not available, the gateway device may determine which devices are available to be associated with the network and include them into the network, step 180. The device may be, for example, light fixtures, ceiling fans, garage door openers, audio or video equipment or other devices that are associated with the network. Each of the devices include a module that controls the device itself and communicates with the gateway device using the wireless network. The modules and Internet gateway may communicate using, for example, radio frequency (RF), infrared light or other type of communication. The gateway device may then monitor the devices associated with the network, step 190.

Operational states for each of the devices associated with the network may be obtained by the gateway device, step 200. Operational states may include, for example, on, off, functioning properly, undetected, malfunctioning or other operational state. Upon obtaining the status of the devices associated with the network, the gateway device may determine whether the devices are functioning properly, step 210. This may include, for example, determining whether any of the devices are broken, missing, unplugged or in another operational state. If a determination is made that a device is not functioning properly, the gateway device may create, a proxy device, step 220.

A proxy device enables the network to remain operational by creating a virtual device that imitates network responses of an actual device that is not functioning properly. The virtual device communicates with controllers on the network in the same manner as the actual, yet non-functioning device by assuming the network and device configuration of the actual device. The virtual device, however, is only a representation of the actual device. This enables the virtual device to appear as the network communication module of the non-functioning device and “deceive” network controllers trying to control the actual device by communicating as though the device is operating properly. This enables the virtual device to circumvent network problems caused by non-responsive devices. Non-responsive devices in a mesh network create undue network traffic because messages are routed and re-routed from device to device in an attempt to find a new path to a non-responsive device. This virtual device works well when an obstacle causes temporary miscommunication to/from a device, but if a device has failed or is incapable of communicating, then the network is burdened with extra traffic every time a failed device is addressed. The lack of a response from a failed device also is indicated as an error or unsuccessful operation on an issuing device such as a hand-held remote being operated by a user. Retry and timeout mechanisms in a user interface of these issuing devices may cause delays in the user experience that are perceived by the user as poor or unacceptable, prompting the user to be dissatisfied with the system. The virtual device maintains system responsiveness and enhances a user's experience.

A notification may be transmitted to a user of the network, step 230, that notifies the user that the device is not functioning properly. If a determination is made that a device is not functioning properly, for example, a missing device may be an outdoor holiday light that has been stored after the holiday season, the user may respond, in step 240, by providing an ignore instruction that informs the gateway device to continue to provide a proxy for the device. If a device is broken and will not be replaced, the user may provide a delete instruction that instructs the gateway device to delete the device from the network. The gateway device may optionally inform and/or update other controllers and devices in the network about the proxy, replacement, and/or deletion of the device in question. Other scenarios may also be provided.

The Gateway device includes a module that determines whether a proxy device needs to be removed from the network, step 250. This may be determined by monitoring the network for the return of an actual non-functioning device to working status. When a device returns to working status from a non-functioning status, the proxy device for the real device is removed, step 260. For example, a fuse or electrical circuit breaker may have tripped and cut-off power to a run of devices in a home. The non-functioning devices will have proxy devices created in their place and maintained by the gateway device. If and when the power is restored to the run of devices, for example, by resetting the circuit breaker or fuse, the gateway device detects the return of the non-functioning devices and removes any corresponding proxies. The detection of the actual devices may be done by periodically disabling the proxy node and attempting to communicate over the network with a real node. Because the proxy is temporarily disabled, only the existence of the real node generates a response to a communication request. If a request is answered during this proxy disabled time, the gateway device determines that the real node has responded. If no response is received in the proxy disable time, then the proxy is re-enabled until the next window of time to look for the real node appears.

If a determination is made that all of the devices associated with the network are functioning properly or a notification has been transmitted to a user, the gateway device may enable a user to create one or more scenes or timed events, step 240. A scene is created by identifying a particular operating state of one or more devices. For example, a scene may be entitled “Work” and establish operating states for various devices for when the user leaves home to go to work. For example, the user may desire that all lights be turned off, a radio in an upstairs bedroom be turned on, and the garage door opener move the garage door to a closed position. A second scene may be entitled “Home” that designates the operating states of one or more devices when the user arrives home from work. The Home scene may turn on lights in the kitchen, hallway, and master bedroom to 40, 60, and 100 percent settings, respectively, the garage door opener be set to open, and a thermostat be set to sixty eight degrees Fahrenheit (68° F.). A scene may be operated or selected using, for example, a remote control, computer interface or other input mechanism.

A timed event may also be created. For example, the Work scene may be created such that the Work scene is triggered at eight A.M. and the Home scene is triggered at six P.M. In this manner, the scenes are triggered automatically based on a clock that is in communication with the gateway device. The gateway device may use an Internal or external clock to determine whether an event should be triggered. In this example, the gateway device may communicate signals to a network device identified in, for example, a scene table or list, that causes the device to be set to a desired setting.

Upon creation of a scene or event, an information table may be generated, step 270. The information table may identify the operating states of the devices whose operating states are changed upon the triggering of the scene and/or event. The table may identify a route which the network communication to and from the network devices may follow. The route that the communication follows may vary depending on obstacles that may be encountered during communication. For example, a garage door opener may have transmitted a network message to the gateway device in a home office or study via a network light switch in the kitchen and then on to a network light switch in an office or study. Recently, however, a stainless steel refrigerator has been positioned in front of the network light switch in the kitchen. If the communication is transmitted using radio frequency (RF), the stainless steel refrigerator may interfere with the signal transmitted to the network light switch in the kitchen. Therefore, the network signal from the garage door opener may be retransmitted or routed to a network light fixture in the living room, then to a network light switch in a hallway, and then to the gateway device in the office or study. Routing of communications among the devices may be dynamic or deliberate, and changed based on various factors. For example, signals may be transmitted using ultra-violet light, infrared light, visible light or other medium. Also, controllers in the network may determine whether a signal was communicated successfully to a particular destination, because each destination device may optionally transmit an acknowledgement signal to the origination device that transmitted the signal. The acknowledgement signal may include information that, for example, states whether the signal was successfully communicated to another controller or device, information about the controller or device that received the signal, the time information when the signal was received, and other information.

The method 100 may also enable remote access to the wireless network, step 280, by enabling a user to log into an Internet-located server and provide instructions for managing the network. The user may log-in to the server and enter a user name and password that enables the user to control the wireless network if tasked with management of the network.

The method 100 may also enable the gateway device to join a network, step 290. This enables the gateway device to join a pre-existing network acting as a device on the network. The gateway device may also add and delete devices from the network [expand].

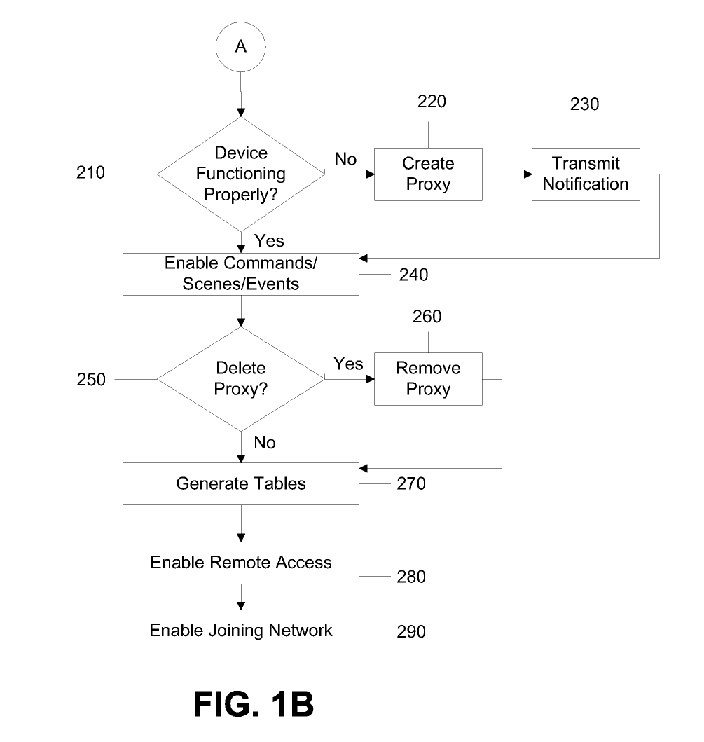

FIG. 2 illustrates a system 300 of controlling a wireless radio frequency network using a gateway device according to one embodiment of the invention. The system 300 may include a network available determining module 310 to determine whether a network is available. If a determination is made that a network is not available, a network creating module 320 may be used to create a network using known network creating methods. If a determination is made that a network is available or after a network has been created, a network identifying module 330 may be used to identify the network available or created as discussed above. A network configuring module 340 may be used to configure the network identified or created as described above.

An Internet availability determining module 350 may be used to determine whether access to the Internet is available. If a determination is made that Internet access is available, a location request generating module 360 may be used to generate a location request for the system 300. The location request generating module 360 transmits a location request such as, for example, a ping, to an Internet server that enables the server to locate the system 300. In this manner, users may access the server to control the system 300.

A device determining module 370 may be used to determine devices associated with the network. The devices may include, for example, network versions of: light switches; light fixtures; garage door openers; thermostats; ceiling fans; sound systems; video equipment; and other household devices. A network monitoring module 380 may be used to monitor the network. A device status determining module 390 may be used to determine a status of the devices associated with the network. A device operating determining module 400 may be used to determine whether the devices associated with the network are operating properly. If a determination is made that a device is not operating properly, a proxy creating module 410 may be used to create a proxy of a device associated with the network. A proxy device permits the system 300 to operate normally although a device may be broken, missing, unplugged or in another non-operational state. If a proxy device is created by the proxy creating module 410, a notification may be transmitted to a user using notification transmitting module 420. A notification may advise the user that a particular device is not functioning properly and enable the use to log-in to the server and provide a command for how that device is to be treated by the system 300.

A scene/event creating module 430 may be used to create one or more scenes or events using the devices associated with the network. The scenes or events may be such as those described above. Additionally, the scenes for secondary controllers in the network may be created by the same means and pushed to the secondary controllers for activation independent of the gateway.

A delete proxy determining module 440 may be used to delete a proxy created by proxy creating module 410. The delete proxy determining module 440 may determine whether a proxy is needed for an actual device by transmitting a signal to the device and determining based on, for example, a device identifier included in a response from the device, whether the actual device or the proxy has responded. If the delete proxy determining module 440 determines that the actual device has responded, a proxy removing module 450 may be used to remove the proxy from the network.

A table generating module may 460 be used to generate information tables that identify devices to be controlled for a scene and identify events that trigger a particular scene such as those discussed above. The table generating module 460 may also generate a routing table that provides routes that signals from each controller may use to communicate with the system 300 and the other controllers as described above.

A network access enabling module 470 may be used to enable the user to access the wireless network via a server on the Internet. The user may log-in to the server using, for example, a username and password that is associated with a wireless network for that user. The user may then provide operating instructions and get status of one or more devices on the network. A network joining enabling module 480 may be used to enable devices to be joined to a network.

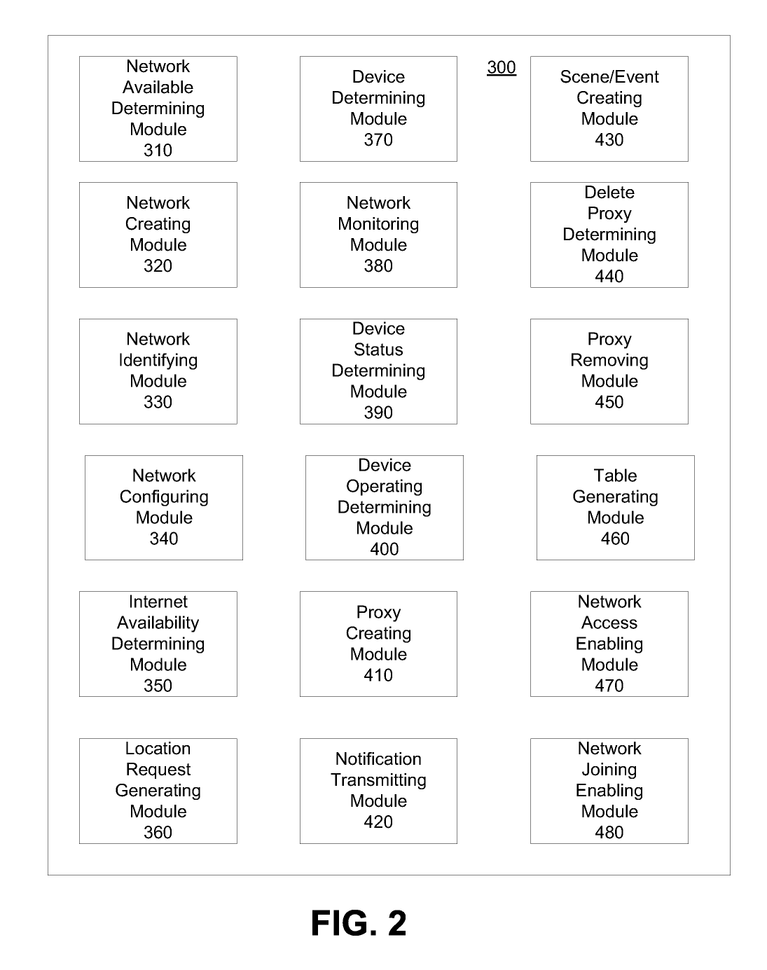

FIG. 3 is a front view of a gateway device 500 that may be used to control a wireless radio frequency network according to one embodiment of the invention. The gateway device 500 may include a logo area 510 that may provide, for example, a logo, trademark, symbol, name or other identifier of a manufacturer, distributor or other party associated with the gateway device 500. A plurality of indicator light emitting devices (LED) 520-550 may be used to provide an indication regarding one or more operational states of the gateway device 500. For example, the gateway device 500 may include a power indicator LED 520 that indicates whether power is being supplied to the gateway device 500, a transmitting indicator LED 530 that indicates that the gateway device 500 is transmitting a signal to a controller, a receiving indicator LED 540 that indicates that the gateway device 500 is receiving a signal or other indicator LED 550.

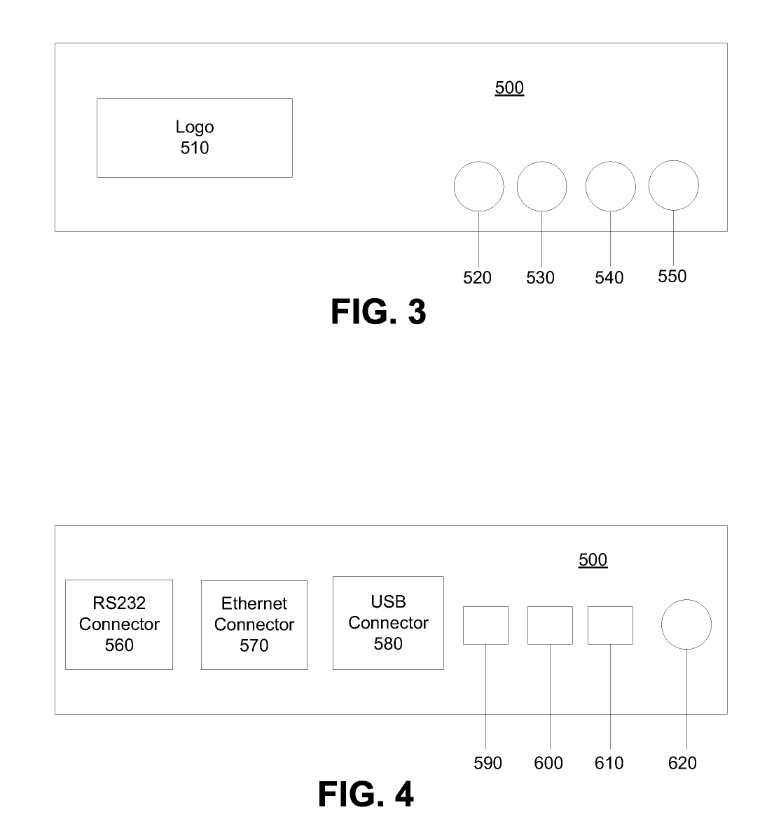

FIG. 4 illustrates a rear view of a gateway device 500 that may be used to control a wireless radio frequency network according to one embodiment of the invention. The gateway device 500 may include a serial port connector such as an RS 232, RS422, or RS485 connector 560, an Ethernet connector 570, and a USB connector 580. The connectors 560-580 may be used to connect the gateway device 500 to a network, computer, and other devices. Selector buttons 590-610 may be provided to enable the user to select that certain functions be performed by the gateway device 500. For example, the gateway device 500 may include a power selector 590 that enables the user to power the gateway device 500 on and off, a reset selector 600 that enables the user to reset the gateway device 500, and other selector 610 that enables the user to perform another function. A power inlet 620 may also be provided to provide a connection to a power source.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of controlling a wireless radio frequency network using a gateway comprising:
determining whether a wireless radio frequency network is available using a gateway;
identifying the network if a determination is made that the network is available;
configuring the network;
determining a household device associated with the network; and
determining a status of the household device associated with the network.

2. The method of claim 1, further comprising communicating a location request to a server that enables the server to locate the gateway.

3. The method of claim 1, further comprising creating a proxy device.

4. The method of claim 3, further comprising removing the proxy device.

5. The method of claim 1, further comprising enabling a user to access the network.

6. The method of claim 1, further comprising communicating a notification to the user regarding the status.

7. The method of claim 1, further comprising creating at least one of a scene and a timed event.

8. The method of claim 1, further comprising monitoring the network.

9. The method of claim 1, wherein the network comprises a Z-WAVE network.

10. The method of claim 1, wherein said determining a household device determines at least one of a type and location of the household device.

11. The method of claim 1, further comprising at least one of creating and joining the network.

12. The method of claim 1, further comprising generating at least one of a scene information table and a routing table based on the household device associated with the network.

13. The method of claim 1, wherein the household device comprises at least one of a light, switch, alarm system, fan, thermostat, window covering, garage door opener, and power outlet.

14. A system of controlling a wireless radio frequency network comprising:
a network determining module to determine whether a wireless radio frequency network is available using a gateway;
a network identifying module to identify the network if a determination is made that the network is available;
a network configuring module to configure the network;
a household device determining module to determine a household device associated with the network; and
a status determining module to determine a status of the household device associated with the network.

15. The system of claim 14, wherein the household device determining module is configured to determine at least one of a type and location of the household device.

16. The system of claim 14, further comprising at least one of a network creating module configured to enable creation of the network and a network joining module configured to enable the gateway to join the network.

17. The system of claim 14, further comprising at least one of a network managing module configured to enable management the network, a network maintaining module configured to maintain the network, and a network monitoring module configured to monitor the network.

18. The system of claim 17, further comprising an Internet connection determining module configured to determine whether an Internet connection is available.

19. The system of claim 18, further comprising a location request communicating module configured to communicate a location request to a server that enables the server to locate the system.

20. The system of claim 14, further comprising a proxy creating module configured to create a proxy device.

21. The system of claim 20, further comprising a proxy device removing module configured to remove the proxy device.

22. The system of claim 14, further comprising an access enabling module configured to enable a user to access the wireless radio frequency network.

23. The system of claim 14, further comprising communicating a notification to the user regarding the status.

24. The system of claim 14, further comprising a creating module configured to create any one of a scene and a timed event.

25. The system of claim 14, wherein the wireless radio frequency network comprises a Z-WAVE network.

26. The system of claim 14, further comprising generating at least one of a scene information table and a routing table based on the user devices associated with the network.

27. The system of claim 14, wherein the devices comprise at least of a light, switch, alarm system, fan, thermostat, window covering, garage door opener, and power outlet.

28. The method of claim 7, further comprising updating secondary controller scene information.

29. The method of claim 7, further comprising updating secondary controller timed events.

30. The method of claim 12, further comprising updating at least one of a secondary controller scene information table and a routing table.

31. A system of updating controllers in a wireless radio frequency network, comprising:
a network configuring module to configure the network;
a household device determining module to determine a household device associated with the network; and
a network scene/event creating module to create scenes and update secondary controllers.
